(19) United States
(12) Patent Application Publication
(10) Pub. No.: US 2009/0244299 A1
(43) Pub. Date: Oct. 1, 2009

(54) Image processing device, computer-readable storage medium, and electronic apparatus

(75) Inventor: Munenori FUKUNISHI, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/409,107

(22) Filed: Mar. 23, 2009

(30) Foreign Application Priority Data
Mar. 24, 2008 (JP) 2008-76303

(51) Int. Cl. H04N 5/228

(52) U.S. Cl. 348/208.4; 348/E05.031

(57) ABSTRACT

An image processing device for performing positioning processing between a plurality of images using a positional displacement amount between the plurality of images generates a positioning image by reducing the plurality of images, sets a motion vector measurement region with which a motion vector is measured in the positioning image, determines a pixel precision motion vector in the positioning image using the motion vector measurement region, and determines a sub-pixel precision motion vector in relation to the pixel precision motion vector. A representative vector is determined on the basis of the determined sub-pixel precision motion vector, and the positional displacement amount between the plurality of images is determined by converting the representative vector at a conversion ratio employed to convert the reduced positioning images into the plurality of images prior to the reduction.

### FIELD OF THE INVENTION

This invention relates to a technique for positioning a plurality of images, including a technique for superimposing images and a technique for correcting image blur.

### BACKGROUND OF THE INVENTION

It is known that in an electronic image pickup apparatus such as a digital camera, image blur due to hand movement or object movement is more likely to occur when a shutter speed is low. Mechanical hand movement correction and electronic hand movement correction may be employed as methods of suppressing image blur due to hand movement. Mechanical hand movement correction may be performed using a lens shift method in which image blur correction is performed by measuring a displacement amount using a gyro sensor or the like and driving a correction optical system for offsetting an image pickup optical axis, or a sensor shift method in which image blur correction is performed by moving an imaging device. Electronic hand movement correction is a method in which multiple frames (multiple images) are captured at high speed, a positional displacement amount between the frames is measured using a sensor or an image processing method, the positional displacement amount is compensated for, and then the frames are integrated to generate an image.

A block matching method is known as a typical technique for determining the positional displacement amount between the frames. In the block matching method, a block of an appropriate size (for example, 8 pixels×8 lines) is defined within a reference frame, a match index value is calculated within a fixed range from a corresponding location of a comparison frame, and a relative displacement amount between the frames in which the match index value is largest (or smallest depending on the index value) is calculated.

The match index value may be a sum of squared intensity difference (SSD), which is a sum of squares of a pixel value difference, a sum of absolute intensity difference (SAD), which is a sum of absolute values of the pixel value difference, and so on. As SSD or SAD decreases, the match is determined to be closer. When pixel values of pixel positions pεI and qεI′ are set respectively as Lp, Lq in a reference block region I and a subject block region I′ of a matching operation, SSD and SAD are respectively expressed by the following Equations (1) and (2). It should be noted that p, q are quantities having two-dimensional values, I and I′ represent two-dimensional regions, and pεI indicates that a coordinate p is included in the region I.

$$\begin{matrix}SSD ( I , {I}^{′} ) = {\sum }_{p ∈ I , q ∈ {I}^{′}} {( Lp - Lq )}^{2} & ( 1 ) \\ SAD ( I , {I}^{′} ) = {\sum }_{p ∈ I , q ∈ {I}^{′}} ‖ ( Lp - Lq ) ‖ & ( 2 )\end{matrix}$$

A method employing a normalized cross-correlation (NCC) also exists. In a zero average correlation, average values Ave (Lp), Ave (Lq) of the pixels pεI and qεI′ included respectively in the reference block region I and the subject block region I′ of the matching operation are calculated. A difference between the pixel values included in the respective blocks is then calculated using the following Equations (3), (4).

$$\begin{matrix}{Lp}^{′} = \frac{Lp - Ave ( Lp )}{\sqrt{\frac{1}{n} {\sum }_{p ∈ I} {( Lp - Ave ( Lp ) )}^{2}}} {\vert}_{p ∈ I} & ( 3 ) \\ {Lq}^{′} = \frac{Lq - Ave ( Lq )}{\sqrt{\frac{1}{n} {\sum }_{q ∈ {I}^{′}} {( Lq - Ave ( Lq ) )}^{2}}} {\vert}_{q ∈ {I}^{′}} & ( 4 )\end{matrix}$$

Next, a normalization cross-correlation NCC is calculated using Equation (5).

NCC=ΣLp′Lq′ (5)

Blocks having a large normalization cross-correlation NCC are determined to be a close match (have a high correlation), and the relative displacement amount between the blocks I′ and I exhibiting the closest match is determined.

In block matching, the calculation required to calculate the SSD, SAD, NCC, and so on for all of the positional displacement amounts within a search range is typically large, and therefore high-speed processing is difficult. Hence, pyramid matching is sometimes employed.

In pyramid matching, multiple image sets having varying reduction ratios are prepared for a frame pair consisting of a reference frame and a comparison frame. First, the positional displacement amount of a frame pair having a large reduction ratio (a small image size) is determined, and on the basis of this positional displacement amount, the positional displacement amount of a frame pair having a small reduction ratio (a large image size) is determined. As a result, the search range of the positional displacement amount is reduced (see JP2004-343483A).

### SUMMARY OF THE INVENTION

An image processing device of an aspect of the present invention for performing positioning processing between a plurality of images using a positional displacement amount between the plurality of images is characterized by comprising a positioning image generation unit that generates a positioning image by reducing the plurality of images, a motion vector measurement region setting unit that sets a motion vector measurement region for which a motion vector is measured in the positioning image, a pixel precision motion vector calculation unit that determines a pixel precision motion vector in the positioning image using the motion vector measurement region, a sub-pixel precision motion vector calculation unit that determines a sub-pixel precision motion vector in relation to the pixel precision motion vector, and a positional displacement amount calculation unit that determines a representative vector on the basis of the sub-pixel precision motion vector, and determines the positional displacement amount between the plurality of images by converting the determined representative vector at a conversion ratio employed to convert the reduced positioning images into the plurality of images prior to the reduction.

An image processing device of another aspect of the present invention for performing positioning processing between a plurality of images using a positional displacement amount between the plurality of images is characterized by comprising a positioning image generation unit that generates a positioning image by reducing the plurality of images, a motion vector measurement region setting unit that sets a plurality of motion vector measurement regions for which a motion vector is measured in the positioning image, a motion vector calculation unit that determines a pixel precision motion vector and a sub-pixel precision motion vector in each of the plurality of motion vector measurement regions in the positioning image, a most numerous motion vector selection unit that selects a most numerous motion vector from pixel precision motion vectors determined respectively in the plurality of motion vector measurement regions, a sub-pixel precision motion vector selection unit that selects, from among the sub-pixel precision motion vectors, a sub-pixel precision motion vector corresponding to each motion vector of the most numerous motion vector, and a positional displacement amount calculation unit that determines a representative vector on the basis of the selected sub-pixel precision motion vectors, and determines the positional displacement amount between the plurality of images by converting the determined representative vector at a conversion ratio employed to convert the reduced positioning images into the plurality of images prior to the reduction.

A computer-readable recording medium of yet another aspect of the present invention stores a program for causing a computer to execute a positioning processing between a plurality of images using a positional displacement amount between the plurality of images. The program is characterized by comprising a step of generating a positioning image by reducing the plurality of images, a step of setting a motion vector measurement region for which a motion vector is measured in the positioning image, a step of determining a pixel precision motion vector in the positioning image using the motion vector measurement region, a step of determining a sub-pixel precision motion vector in relation to the pixel precision motion vector, and a step of determining a representative vector on the basis of the sub-pixel precision motion vector, and determining the positional displacement amount between the plurality of images by converting the determined representative vector at a conversion ratio employed to convert the reduced positioning images into the plurality of images prior to the reduction.

A computer-readable recording medium of yet another aspect of the present invention stores a program for causing a computer to execute a positioning processing between a plurality of images using a positional displacement amount between the plurality of images. The program is characterized by comprising a step of generating a positioning image by reducing the plurality of images, a step of setting a plurality of motion vector measurement regions for which a motion vector is measured in the positioning image, a step of determining a pixel precision motion vector and a sub-pixel precision motion vector in each of the plurality of motion vector measurement regions in the positioning image, a step of selecting a most numerous motion vector from pixel precision motion vectors determined respectively in the plurality of motion vector measurement regions, a step of selecting, from among the sub-pixel precision motion vectors, a sub-pixel precision motion vector corresponding to each motion vector of the most numerous motion vector, and a step of determining a representative vector on the basis of the selected sub-pixel precision motion vectors, and determining the positional displacement amount between the plurality of images by converting the determined representative vector at a conversion ratio employed to convert the reduced positioning images into the plurality of images prior to the reduction.

According to these aspects, there is no need to calculate positional displacement amounts repeatedly in relation to a plurality of frames having different reduction ratios, as described in JP2004-343483A, for example, and therefore positioning can be performed on a plurality of images at high speed.

### BRIEF DESCRIPTION OF THE DRAWINGS

FIG. 1 is a block diagram showing the constitution of an image processing device according to a first embodiment of this invention.

FIG. 2 is a view showing a processing flow of the first embodiment.

FIG. 3A is a view showing a template region set in a positioning image (subject frame).

FIG. 3B is a view showing a search region set in a positioning image (reference frame).

FIG. 4A is a view showing an example of a motion vector determined in each template region.

FIG. 4B is a view showing an example of a state in which motion vectors having a low reliability have been removed and motion vectors having a high reliability have been selected.

FIG. 5 is a view showing positional displacement amount voting processing according to the first embodiment.

FIG. 6 is a view showing a motion vector calculation method with sub-pixel precision, according to the first embodiment.

FIG. 7A is a view showing a method of determining a motion vector with sub-pixel precision using equiangular linear fitting.

FIG. 7B is a view showing a method of determining a motion vector with sub-pixel precision using parabola fitting.

FIG. 8 is a block diagram showing the constitution of an image processing device according to a second embodiment of this invention.

FIG. 9 is a view showing a processing flow of the second embodiment.

FIG. 10 is a block diagram showing the constitution of an image processing device according to a third embodiment of this invention.

### DESCRIPTION OF THE PREFERRED EMBODIMENTS

Embodiments of this invention will be described below with reference to the drawings.

### First Embodiment

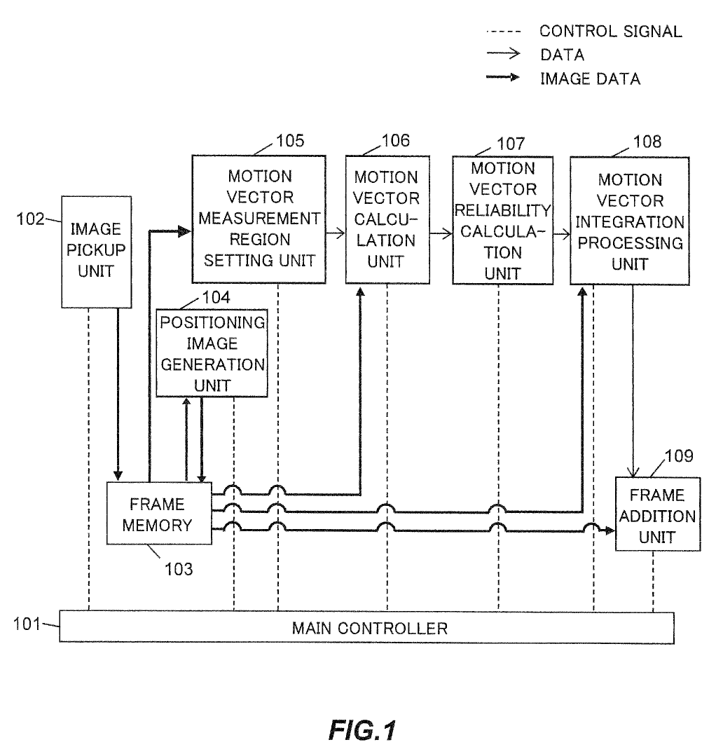

FIG. 1 is a block diagram showing the constitution of an image processing device for performing electronic blur correction according to a first embodiment. In the figure, dotted lines denote control signals, thin lines denote the flow of data such as reliability values and positional displacement amounts, and thick lines denote the flow of image data. The image processing device according to this embodiment is installed in an electronic apparatus. The electronic apparatus is a device that depends on an electric current or an electromagnetic field in order to work correctly, and may be a device such as an electronic calculator, a digital camera, a digital video camera, or an endoscope, for example.

A main controller 101 is a processor for performing operation control of the entire device. The main controller 101 performs command generation and status management in relation to respective processing blocks.

Multiple image frames captured by an image pickup unit 102 are stored in a frame memory 103. A plurality of frame data stored in the frame memory 103 includes the data of a frame (to be referred to hereafter as a reference frame) serving as a positioning reference and the data of a frame (to be referred to hereafter as a subject frame) to be positioned with the reference frame.

A positioning image generation unit 104 (to be referred to hereafter simply as a generation unit 104) converts both the reference frame and the subject frame into images suitable for positioning so as to generate a positioning image (reference frame) and a positioning image (subject frame). The positioning image (reference frame) is an image generated from the reference frame image, and the positioning image (subject frame) is an image generated from the subject frame image. The positioning image (reference frame) and the positioning image (subject frame) will be described in detail below.

A motion vector measurement region setting unit 105 (to be referred to hereafter simply as a setting unit 105) sets a plurality of motion vector measurement regions with which motion vectors are measured in the positioning images. More specifically, a template region serving as a positioning reference region and a search range serving as a positioning range are set on the basis of the positioning image (reference frame) and the positioning image (subject frame). The template region and the search range will be described in detail below.

A motion vector calculation unit 106 (to be referred to hereafter simply as a calculation unit 106) determines a motion vector with pixel precision for each of the plurality of motion vector setting regions in the positioning images. More specifically, a motion vector (pixel precision) representing mapping from the subject frame to the reference frame is calculated using the positioning image (reference frame) and the positioning image (subject frame) stored in the frame memory 103 and the template region and the search range set by the setting unit 105. A method of calculating the motion vector will be described below.

A motion vector reliability calculation unit 107 (to be referred to hereafter simply as a reliability calculation unit 107) calculates a reliability, which represents the likelihood of a processing result, for each of the motion vectors (pixel precision) calculated by the calculation unit 106. A method of calculating the reliability will be described below.

A motion vector integration processing unit 108 (to be referred to hereafter simply as a processing unit 108) first selects a plurality of highly reliable motion vectors on the basis of the reliability of the motion vectors, and then selects the most numerous motion vectors from among the selected plurality of highly reliable motion vectors. Next, the processing unit 108 determines motion vectors having sub-pixel precision, i.e. a higher degree of precision than pixel precision, in relation to the selected most numerous motion vectors, and then determines a representative vector on the basis of the motion vectors having sub-pixel precision The processing unit 108 then determines an inter-image positional displacement amount by directly converting the determined representative vector at a conversion ratio employed when the reduced positioning images are converted into the plurality of pre-reduction images. The processing performed by the processing unit 108 will be described in detail below.

A frame addition unit 109 shifts the subject frame on the basis of the reference frame, the subject frame, and the inter-image positional displacement amount, and adds the shifted subject frame to a predetermined frame memory.

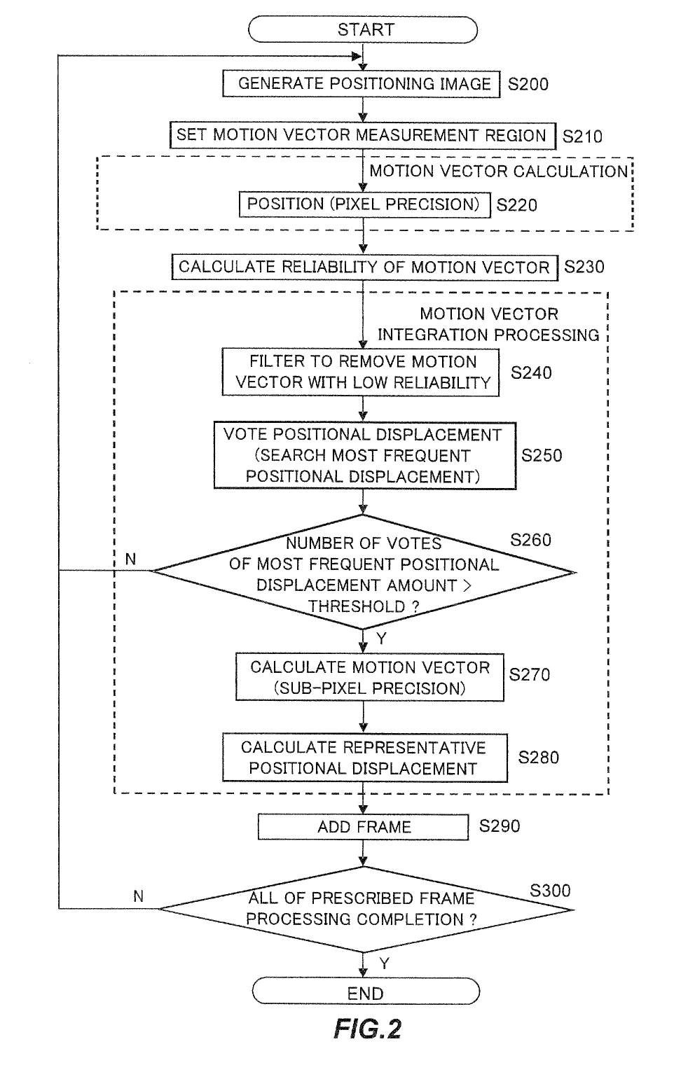

FIG. 2 is a flowchart showing a processing procedure of processing performed by the image processing device according to the first embodiment. In a step S200, the generation unit 104 generates the positioning image (reference frame) and the positioning image (subject frame) as positioning images in relation to each of the reference frame and the subject frame stored in the frame memory 103. The positioning image (reference frame) and the positioning image (subject frame) are obtained by reducing the reference frame and the subject frame, respectively.

In a step S210, the setting unit 105 sets motion vector measurement regions in lattice form in the positioning images.

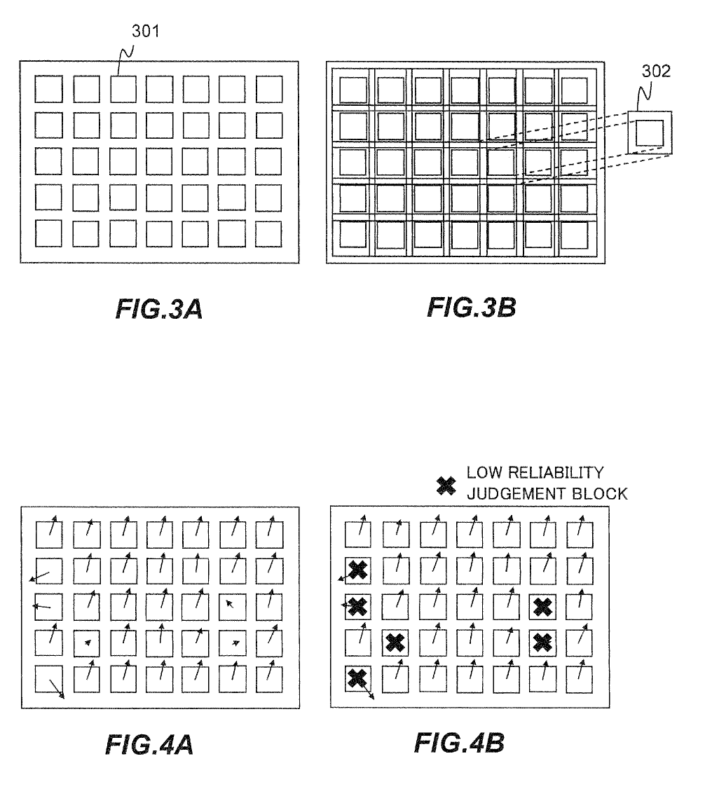

FIG. 3A is a view showing template regions 301, which serve as positioning reference regions set in the positioning image (subject frame), or in other words motion vector measurement regions. As shown in FIG. 3A, the template region 301 is a rectangular region of a predetermined size, which is used in the motion vector measurement (motion vector detection) to be described below.

FIG. 3B is a view showing search regions 302 set in the positioning image (reference frame). The search region 302 is set in the positioning image (reference frame) in the vicinity of coordinates corresponding to the template region 301 and in a wider range than the template region.

It should be noted that the template region 301 used in the motion vector measurement may be disposed in the positioning image (reference frame) and the search region 302 may be disposed in the positioning image (subject frame) in the vicinity of coordinates corresponding to the template region 301.

In a step S220, the calculation unit 106 performs a motion vector calculation using information relating to the positioning image (reference frame) and positioning image (subject frame) stored in the frame memory 103, the template region 301, and the search region 302. In the motion vector calculation, a pixel precision motion vector is determined by positioning the template region 301 of the positioning image (subject frame) within the search region 302 of the positioning image (reference frame). This positioning may be performed using a block matching method for calculating a match index value such as the SAD, SSD, or NCC.

Block matching may be replaced by an optical flow technique. The pixel precision motion vector is determined for each template region 301.

In a step S230, the reliability calculation unit 107 calculates the reliability of each pixel precision motion vector calculated in the step S220. The reliability of the motion vector is determined using a deviation between a match index value of a location having the closest match in a histogram of the match index values determined in the motion vector calculation and an average value, for example. When the SSD is used as the match index value, for example, a deviation between a minimum value and an average value of the SSD is used. Simply, the deviation between the minimum value and average value of the SSD is set as the reliability.

A reliability based on the statistical property of the SSD corresponds to the structural features of the region through the following concepts (i) to (iii).

(i) In a region having a sharp edge structure, the reliability of the motion vector is high. As a result, few errors occur in the position exhibiting the minimum value of the SSD. When a histogram of the SSD is created, small difference values are concentrated in the vicinity of the position exhibiting the minimum value. Accordingly, the difference between the minimum value and average value of the SSD is large.

(ii) In the case of a textured or flat structure, the histogram of the difference value has flat properties. As a result, the difference between the minimum value and the average value is small, and therefore the reliability is low.

(iii) In the case of a repeating structure, the positions exhibiting the minimum value and a maximum value of the difference are close, and positions exhibiting a small difference value are dispersed. As a result, the difference between the minimum value and the average value is small, and the reliability is low.

It should be noted that the reliability may be determined in accordance with an edge quantity of each block.

The processing of steps S240 to S280 is executed by the processing unit 108. In the step S240, highly reliable motion vectors are selected on the basis of the reliability of each motion vector.

FIG. 4A is a view showing an example of motion vectors determined in the respective template regions 301, and FIG. 4B is a view showing an example of a state in which motion vectors having a low reliability have been removed and motion vectors having a high reliability have been selected. In the example shown in FIG. 4B, the highly reliable motion vectors are selected by performing filtering processing to remove the motion vectors having a low reliability (for example, motion vectors having a reliability that is lower than a predetermined threshold).

In the step S250, voting processing is performed on the plurality of motion vectors selected in the selection processing of the step S240 to select the motion vector having the highest frequency, or in other words the most numerous motion vectors.

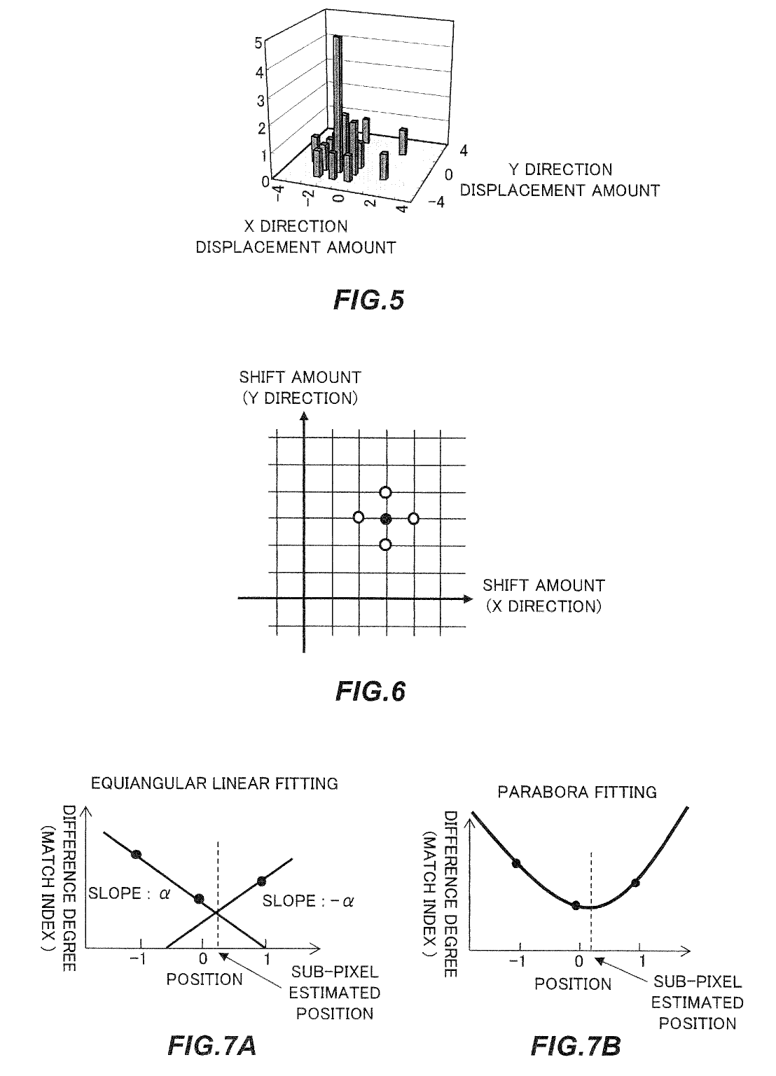

FIG. 5 is a view showing an example of a result of the voting processing executed on the selected motion vectors. The most frequent motion vector is determined by performing voting processing in which the motion vectors selected in the selection processing are separated into an X direction displacement amount and a Y direction displacement amount.

In the step S260, a determination regarding the possibility of frame addition is made on the pixel precision motion vectors remaining after the processing of the steps S240 and S250 by comparing the numbers thereof (the number of votes of the most frequent positional displacement amount) to a predetermined threshold. When the number of votes is smaller than the predetermined threshold, the routine returns to the step S200 without performing frame addition, whereupon the processing is performed on the next frame. When the number of votes equals or exceeds the threshold, frame addition is performed, and the routine therefore advances to the step S270.

In the step S270, a motion vector having sub-pixel precision, a sub-pixel being a smaller unit than a pixel, is determined for the most frequent motion vector. For this purpose, first, match index values are re-determined in four pixel positions, namely the closest upper, lower, left and right pixel positions to the pixel position of the most frequent motion vector (pixel precision). The pixel position of the most frequent motion vector is the pixel position in which the SSD is at a minimum when the SSD is determined as the match index value, for example.

FIG. 6 is a view showing the closest upper, lower, left and right pixel positions to the pixel position of the most frequent motion vector. The pixel position of the most frequent motion vector is indicated by a black circle, and the closest upper, lower, left and right pixel positions are indicated by white circles.

Next, the match index values determined in the closest upper, lower, left and right pixel positions are subjected to fitting to determine a peak position of the match index values, whereby the sub-pixel precision motion vector (shift amount) is determined. A well-known method such as equiangular linear fitting or parabola fitting may be used as the fitting method.

FIG. 7A is a view showing a method of determining the sub-pixel precision motion vector using equiangular linear fitting. For example, when the match index value in the pixel position having a maximum match index value by pixel unit is set as R (0), and the match index values of the pixel positions immediately to the left and right of the pixel position having the maximum match index value are set as R(−1) and R(1), respectively, a sub-pixel precision displacement amount dn in the X direction is expressed by the following Equation (6).

$$dn = \{ \begin{matrix}\frac{1}{2} \frac{R ( 1 ) - R ( - 1 )}{R ( 0 ) - R ( - 1 )} when R ( 1 ) < R ( - 1 ) \\ \frac{1}{2} \frac{R ( 1 ) - R ( - 1 )}{R ( 0 ) - R ( 1 )} when R ( 1 ) \geq R ( - 1 )\end{matrix} \qquad ( 6 )$$

By determining a sub-pixel precision displacement amount in the Y direction in a similar manner using Equation (6) with the match index values of pixel positions immediately above and below set as R(1) and R(−1), respectively, the sub-pixel precision motion vector is determined.

FIG. 7B is a view showing a method of determining the sub-pixel precision motion vector using parabola fitting. In this case, the sub-pixel precision displacement amount dn is expressed by the following Equation (7).

$$dn = \frac{R ( - 1 ) - R ( 1 )}{2 R ( - 1 ) - 4 R ( 0 ) + 2 R ( 1 )} \qquad ( 7 )$$

Likewise in this case, by determining sub-pixel precision displacement amounts in the X direction and the Y direction on the basis of Equation (7), the sub-pixel precision motion vector is determined.

The processing to determine the sub-pixel precision motion vector is performed on all motion vectors of the most frequent motion vector determined in the step S250.

In the step S280, a representative positional displacement amount is determined. For this purpose, first, an average vector of the plurality of sub-pixel precision motion vectors determined in the step S270 is determined as a representative vector. The positioning image (reference frame) and the positioning image (subject frame) are both reduced images obtained by reducing the reference frame and the subject frame, and therefore the representative positional displacement amount is determined by converting the determined average vector at a magnification ratio of the pre-reduction input frames. The magnification ratio of the pre-reduction input frames is a conversion ratio employed when the reduced positioning images are converted into the plurality of pre-reduction images, and is calculated as the inverse of a reduction ratio employed when the positioning image (reference frame) and the positioning image (subject frame) are generated from the reference frame and the subject frame. For example, when the positioning image (reference frame) and the positioning image (subject frame) are generated by respectively reducing the reference frame and the subject frame to a quarter of their original size, the representative positional displacement amount is determined by quadrupling the determined average vector.

At this time, the precision of the representative positional displacement amount, or in other words the precision of the positional displacement during frame addition, can be switched to an arbitrary precision by multiplication-converting the average vector after quantizing the average vector to an arbitrary resolution. In particular, the average vector is preferably updated such that the determined representative positional displacement amount exhibits pixel precision. For example, when the average vector is (2.2, 2.6) and the conversion ratio is fourfold, the average vector becomes (8.8, 10.4) if simply quadrupled, and therefore pixel precision is not obtained. By updating the average vector to (2.0, 2.5) before quadrupling it, on the other hand, a pixel precision representative positional displacement amount (8, 10) can be obtained.

It should be noted that as a modified example, a most frequent motion vector having sub-pixel precision may be determined by determining sub-pixel precision motion vectors for the group of most frequent pixel precision motion vectors and performing re-voting processing at a fixed resolution in relation to the respective sub-pixel precision motion vectors. The representative positional displacement amount may then be determined by converting the most frequent motion vector by the magnification of the input frames (similarly to the concept shown in FIG. 5). In this case, the image positioning precision can be switched arbitrarily according to the resolution employed during re-voting.

In a step S290, addition of the subject frame and the reference frame is performed by shifting the subject frame using the representative positional displacement amount determined in the step S280 and then adding the shifted subject frame to a predetermined frame memory.

In a step S300, a determination is made as to whether or not processing has been performed on all of the prescribed frames. When processing has been performed on all of the prescribed frames, the processing of the flowchart is terminated, and when an unprocessed frame remains, the routine returns to the step S200, whereupon the processing described above is repeated.

Incidentally, in an electronic blur correction technique employing a pyramid search, disclosed in JP2004-343483A of the prior art, for example, a frame pair consisting of a reference frame and a comparison frame is first reduced to a frame pair having small image sizes, whereupon the positional displacement amount is determined in the reduced frame pair. With this method, the determined positional displacement amount remains in pixel units, and therefore the precision of the positional displacement amount cannot be said to be high.

According to the image processing device of the first embodiment, on the other hand, the reduced images are positioned on the pixel level, whereupon a positional displacement amount having sub-pixel precision is estimated from a match index value of the initial positioning with the pixel level, and then the estimated sub-pixel precision positional displacement amount is multiplied by the magnification ratio of the original images. Hence, according to this device, positioning between a plurality of images is performed on the basis of a positional displacement amount having sub-pixel precision rather than pixel precision, and therefore the result of the positioning is highly precise. Moreover, according to this device, there is no need to calculate the positional displacement amount repeatedly for a plurality of frames having different reduction ratios, as in JP2004-343483A, for example, and therefore blur correction and positioning can be performed at a higher speed than conventional blur correction and positioning.

Furthermore, according to the image processing device of the first embodiment, the sub-pixel precision positional displacement amount is calculated by calculating the match index value only in the vicinity of the pixel precision positional displacement amount, and therefore the calculation cost for determining the sub-pixel precision motion vector is small relative to the overall calculation cost and has little effect on the processing time. Hence, frame addition at an arbitrary degree of positioning precision can be realized without greatly altering the calculation cost. Therefore, blur correction and positioning can be performed within a smaller processing period than conventional blur correction and positioning.

### Second Embodiment

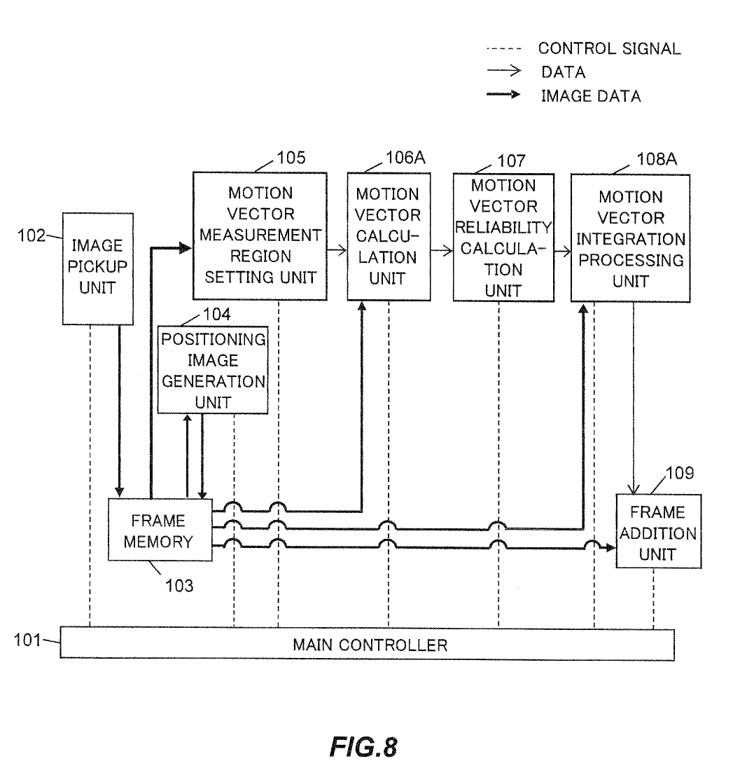

FIG. 8 is a block diagram showing the constitution of an image processing device for performing electronic blur correction, according to a second embodiment. Identical constitutional elements to the constitutional elements of the image processing device according to the first embodiment, shown in FIG. 1, have been allocated identical reference symbols, and detailed description thereof has been omitted.

The image processing device according to this embodiment differs from the image processing device according to the first embodiment shown in FIG. 1 in that both the pixel precision motion vector and the sub-pixel precision motion vector are calculated in a motion vector calculation unit 106A (to be referred to hereafter simply as a calculation unit 106A). Hence, in the calculation unit 106A, the pixel precision motion vector and the sub-pixel precision motion vector are determined on the basis of the positioning image (reference frame), the positioning image (subject frame), the template region 301, and the search range 302.

A motion vector integration processing unit 108A (to be referred to hereafter simply as a processing unit 108A) performs motion vector integration on the basis of the pixel precision motion vectors and sub-pixel precision motion vectors calculated by the calculation unit 106A and the reliability values of the pixel precision motion vectors, and thereby calculates a representative positional displacement amount expressing inter-frame motion. The reliability of the pixel precision motion vector is calculated by a motion vector reliability calculation unit 107A (to be referred to hereafter simply as a reliability calculation unit 107A).

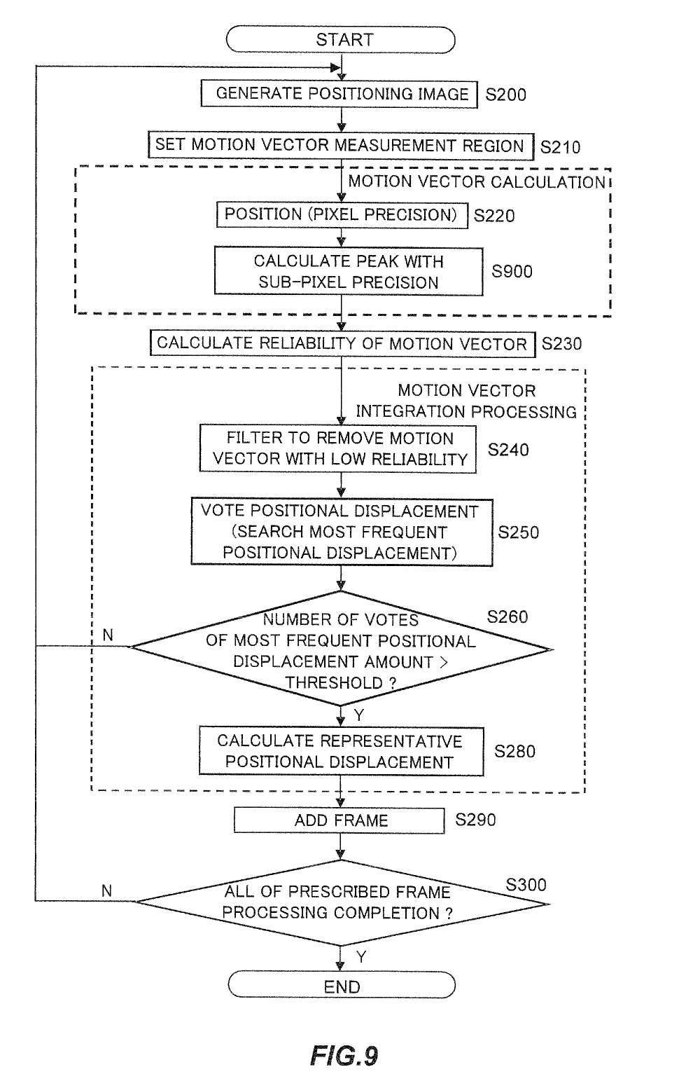

FIG. 9 is a flowchart showing a processing procedure of processing performed by the image processing device according to the second embodiment. Steps in which identical processing to the processing of the flowchart shown in FIG. 2 is performed have been allocated identical step numbers, and detailed description thereof has been omitted. The following description focuses on differences in the processing.

The processing of the step S220 and a step S900 is performed by the calculation unit 106A. In the step S900, sub-pixel precision motion vectors are determined by re-determining match index values in the closest upper, lower, left and right pixel positions to the pixel position having the match index value that exhibits the closest match, from among the match index values calculated during determination of the pixel precision motion vectors in the step S220. The method of determining the sub-pixel precision motion vectors is identical to that of the first embodiment, and therefore detailed description thereof has been omitted.

Hence, the calculation unit 106A determines the pixel precision motion vectors and the sub-pixel precision motion vectors using the respective template regions 301 as subjects.

The processing of the steps S240 to S260 and S280 is performed by the processing unit 108A. When it is determined in the step S260 that the number of votes of the most frequent motion vector (pixel precision) is equal to or greater than the predetermined threshold, the routine advances to the step S280.

In the step S280, the representative positional displacement amount is determined. For this purpose, first, a plurality of sub-pixel precision motion vectors corresponding respectively to the plurality of most frequent pixel precision motion vectors determined in the step S250 are selected from the plurality of sub-pixel precision motion vectors determined in the step S900, whereupon an average vector of the selected plurality of sub-pixel precision motion vectors is determined. The representative positional displacement amount is then determined by converting the determined average vector at the magnification ratio of the pre-reduction input frames.

In the image processing device according to the second embodiment, similarly to the image processing device according to the first embodiment, frame addition at an arbitrary degree of positioning precision can be realized without greatly altering the calculation cost. As a result, blur correction can be performed with a high degree of precision and within a smaller processing period than conventional blur correction.

### Third Embodiment

In the first and second embodiments described above, examples of frame addition were illustrated, but moving image blur correction may be performed by performing image shifting on the subject frame relative to the reference frame on the basis of a motion vector representative value.

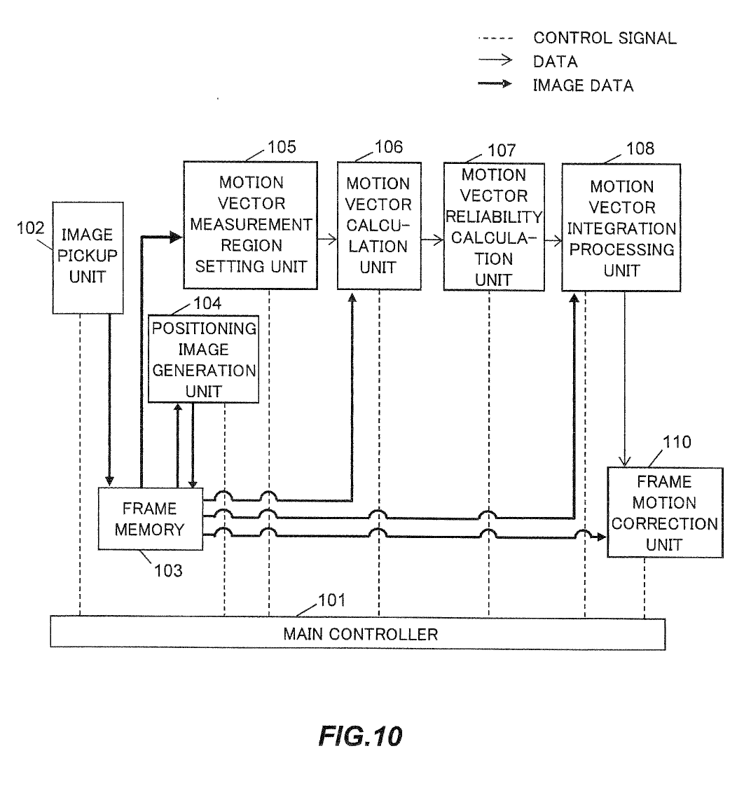

FIG. 10 is a block diagram showing the constitution of an image processing device according to a third embodiment. The image processing device according to the third embodiment differs from the image processing device according to the first embodiment shown in FIG. 1 in having a frame motion correction unit 110 (to be referred to hereafter simply as a correction unit 110) instead of the frame addition unit 109.

The correction unit 110 performs processing to correct the subject frame so as to reduce blur relative to the reference frame on the basis of the representative positional displacement amount determined by the processing unit 108. Corrected data are transferred to a display device, not shown in the figures, or a storage device, not shown in the figures.

In the above description of the first to third embodiments, it is assumed that the processing performed by the image processing device is hardware processing, but this invention need not be limited to such a constitution. For example, a constitution in which the processing is performed by software may be employed In this case, the image processing device includes a CPU, a main storage device such as a RAM, and a computer-readable storage medium storing a program for realizing all or a part of the processing described above. Here, the program is referred to as an image processing program. By having the CPU read the image processing program stored on the storage medium and execute information processing/calculation processing, similar processing to that of the image processing device described above is realized.

Here, a computer-readable storage medium denotes a magnetic disk, a magneto-optical disk, a CD-ROM, a DVD-ROM, a semiconductor memory, and so on. Further, the image processing program may be distributed to a computer by a communication line, whereupon the computer executes the received distributed image processing program.

This invention is not limited to the embodiments described above, and may be subjected to various modifications and applications within a scope that does not depart from the spirit of the invention. Several of these modified examples will be described below.

In the embodiments, an average vector of a plurality of sub-pixel precision motion vectors is determined as the representative (conversion reference) vector, but this invention is not limited thereto. As a modified example, the processing unit 108 may select one motion vector from the plurality of sub-pixel precision motion vectors and use the selected motion vector as the representative vector. Various selection methods may be used, but as a single example, a motion vector positioned in a location of the image having a high contrast may be selected as the representative vector.

The pixel precision motion vectors may be determined using the following procedure. First, a single motion vector measurement region with which the motion vector is to be measured is set in the positioning image, and then the template region 301 serving as the motion vector measurement region is moved to each pixel of the positioning image. As this movement progresses, correspondence relationship information between position information indicating the image position of the motion vector measurement region and a match index value corresponding to the pixel value of the pixel included in the motion vector measurement region is stored. An index value such as the above-described SSD, SAC and NCC is used as the match index value. Next, a match index value indicating the matching degree of the motion vector measurement region is obtained every time the motion vector measurement region is moved to another pixel. When the obtained match index value indicates a closer match than the match index value that is already stored, the stored correspondence relationship information is updated to correspondence relationship information between the newly obtained match index value and the position information for the motion vector measurement region corresponding to the match index value. The position information stored at the movement completion point of the motion vector measurement region is then referenced, and the image position indicated by the position information is set as the pixel position in which the pixel precision motion vector is positioned. According to this method, there is no need to perform the two processing procedures of the method described in the first embodiment, i.e. first determining a pixel precision motion vector in each of a plurality of motion vector measurement regions and then selecting the most numerous motion vectors from the determined plurality of pixel precision motion vectors.

It should be noted that when the pixel precision motion vector is determined using the above procedure, a motion vector calculation unit includes a movement unit, a storage unit, and an updating unit. The movement unit moves the motion vector measurement region to each pixel of the positioning image. The storage unit stores the correspondence relationship information between the position information indicating the image position of the motion vector measurement region and the match index value corresponding to the pixel value of the pixel included in the motion vector measurement region. The updating unit obtains the match index value of the motion vector measurement region every time the motion vector measurement region is moved to another pixel, and when the obtained match index value indicates a closer match than the match index value stored in the storage unit, updates the correspondence relationship information stored in the storage unit to correspondence relationship information between the obtained match index value and the position information for the motion vector measurement region corresponding to the match index value.

Further, when the pixel position of the pixel precision motion vector is determined using the above procedure, only one pixel precision motion vector is determined. In this case, a sub-pixel precision motion vector is determined in a proximal range to the pixel position of the determined motion vector, and the determined sub-pixel precision motion vector is used as the representative vector. Hence, by converting the representative vector by the conversion ratio employed when converting the reduced positioning images into the plurality of pre-reduction images, a representative positional displacement amount between a plurality of images can be determined.

This application claims priority based on JP2008-76303, filed with the Japan Patent Office on Mar. 24, 2008, the entire contents of which are incorporated into this specification by reference.

What is claimed is:

1. An image processing device for performing positioning processing between a plurality of images using a positional displacement amount between the plurality of images, comprising:
a positioning image generation unit that generates a positioning image by reducing the plurality of images;
a motion vector measurement region setting unit that sets a motion vector measurement region with which a motion vector is measured in the positioning image;
a pixel precision motion vector calculation unit that determines a pixel precision motion vector in the positioning image using the motion vector measurement region;
a sub-pixel precision motion vector calculation unit that determines a sub-pixel precision motion vector in relation to the pixel precision motion vector; and
a positional displacement amount calculation unit that determines a representative vector on the basis of the sub-pixel precision motion vector, and determines the positional displacement amount between the plurality of images by converting the determined representative vector at a conversion ratio employed to convert the reduced positioning images into the plurality of images prior to the reduction.

2. The image processing device as defined in claim 1, wherein the motion vector measurement region setting unit sets a plurality of the motion vector measurement regions in the positioning image,
the pixel precision motion vector calculation unit determines the pixel precision motion vector for each of the plurality of motion vector measurement regions in the positioning image, and
the sub-pixel precision motion vector calculation unit selects a most numerous motion vectors from the plurality of pixel precision motion vectors determined respectively in the plurality of motion vector measurement regions, and determines the sub-pixel precision motion vector in relation to the selected most numerous motion vectors.

3. The image processing device as defined in claim 2, wherein the sub-pixel precision motion vector calculation unit comprises:
a motion vector reliability calculation unit that calculates a reliability of the pixel precision motion vectors determined respectively in the plurality of motion vector measurement regions; and
a highly reliable motion vector selection unit that selects a highly reliable motion vector from the pixel precision motion vectors on the basis of the reliability of the motion vectors, and
the sub-pixel precision motion vector calculation unit selects the most numerous motion vectors from a plurality of the highly reliable motion vectors, and determines the sub-pixel precision motion vector in relation to the selected most numerous motion vectors.

4. The image processing device as defined in claim 2, wherein the sub-pixel precision motion vector calculation unit determines a plurality of sub-pixel precision motion vectors in relation to respective motion vectors of the selected most numerous motion vectors, and
the representative vector is an average vector determined on the basis of the plurality of sub-pixel precision motion vectors.

5. The image processing device as defined in claim 2, wherein the positional displacement amount calculation unit comprises:
a conversion ratio calculation unit that calculates a conversion ratio used when converting the reduced positioning images into the plurality of images prior to reduction; and
a representative vector updating unit that updates the determined representative vector such that a motion vector obtained by converting the determined representative vector at the conversion ratio exhibits pixel precision, and
the positional displacement amount calculation unit determines the positional displacement amount between the plurality of images by converting the updated representative vector at the conversion ratio.

6. The image processing device as defined in claim 5, wherein the representative vector updating unit updates the determined representative vector through quantization based on the conversion ratio such that the motion vector exhibits pixel precision following conversion at the conversion ratio.

7. The image processing device as defined in claim 2, wherein the positional displacement amount calculation unit comprises a conversion ratio calculation unit that calculates a conversion ratio used when converting the reduced positioning images into the plurality of images prior to the reduction, and
the positional displacement amount calculation unit directly converts the determined representative vector at the conversion ratio.

8. The image processing device as defined in claim 2, wherein the sub-pixel precision motion vector calculation unit determines the sub-pixel precision motion vector when a number of the most numerous motion vectors is equal to or greater than a predetermined threshold.

9. The image processing device as defined in claim 2, wherein the sub-pixel precision motion vector calculation unit determines the sub-pixel precision motion vector within a proximal range of a pixel position in which the most numerous motion vector is positioned.

10. The image processing device as defined in claim 1, wherein the pixel precision motion vector calculation unit comprises:
a movement unit that moves the motion vector measurement region to each pixel on the positioning image;
a storage unit that stores correspondence relationship information between position information indicating an image position of the motion vector measurement region and a match index value corresponding to a pixel value of a pixel included in the motion vector measurement region; and
an updating unit that obtains the match index value of the motion vector measurement region every time the motion vector measurement region is moved to a different pixel, and when the obtained match index value indicates a closer match than a match index value stored in the storage unit, updates the correspondence relationship information stored in the storage unit to correspondence relationship information between the obtained match index value and the position information of the motion vector measurement region corresponding to the match index value, and
the pixel precision motion vector calculation unit refers to the position information stored in the storage unit when movement of the motion vector measurement region is complete, and sets an image position indicated by the position information as a pixel position in which the pixel precision motion vector is positioned.

11. The image processing device as defined in claim 10, wherein the sub-pixel precision motion vector calculation unit determines the sub-pixel precision motion vector within a proximal range of the pixel position in which the pixel precision motion vector is positioned.

12. The image processing device as defined in claim 1, further comprising an addition unit that shifts an image in which positional displacement has occurred on the basis of the positional displacement amount, and adds the shifted image to a reference image.

13. The image processing device as defined in claim 1, further comprising a shifting unit that shifts an image in which positional displacement has occurred on the basis of the positional displacement amount.

14. An image processing device for performing positioning processing between a plurality of images using a positional displacement amount between the plurality of images, comprising:
a positioning image generation unit that generates a positioning image by reducing the plurality of images;
a motion vector measurement region setting unit that sets a plurality of motion vector measurement regions with which a motion vector is measured in the positioning image;
a motion vector calculation unit that determines a pixel precision motion vector and a sub-pixel precision motion vector in each of the plurality of motion vector measurement regions in the positioning image;
a most numerous motion vector selection unit that selects a most numerous motion vectors from pixel precision motion vectors determined respectively in the plurality of motion vector measurement regions;
a sub-pixel precision motion vector selection unit that selects, from among the sub-pixel precision motion vectors, a sub-pixel precision motion vector corresponding to each motion vector of the most numerous motion vectors; and
a positional displacement amount calculation unit that determines a representative vector on the basis of the selected sub-pixel precision motion vectors, and determines the positional displacement amount between the plurality of images by converting the determined representative vector at a conversion ratio employed to convert the reduced positioning images into the plurality of images prior to the reduction.

15. An electronic apparatus having the image processing device as defined in claim 1.

16. An electronic apparatus having the image processing device as defined in claim 14.

17. A computer-readable recording medium storing a program for causing a computer to execute a positioning processing between a plurality of images using a positional displacement amount between the plurality of images, wherein the program comprises:
a step of generating a positioning image by reducing the plurality of images;
a step of setting a motion vector measurement region with which a motion vector is measured in the positioning image;
a step of determining a pixel precision motion vector in the positioning image using the motion vector measurement region;
a step of determining a sub-pixel precision motion vector in relation to the pixel precision motion vector; and
a step of determining a representative vector on the basis of the sub-pixel precision motion vector, and determining the positional displacement amount between the plurality of images by converting the determined representative vector at a conversion ratio employed to convert the reduced positioning images into the plurality of images prior to the reduction.

18. A computer-readable recording medium storing a program for causing a computer to execute a positioning processing between a plurality of images using a positional displacement amount between the plurality of images, wherein the program comprises:
a step of generating a positioning image by reducing the plurality of images;
a step of setting a plurality of motion vector measurement regions with which a motion vector is measured in the positioning image;
a step of determining a pixel precision motion vector and a sub-pixel precision motion vector in each of the plurality of motion vector measurement regions in the positioning image;
a step of selecting most numerous motion vectors from pixel precision motion vectors determined respectively in the plurality of motion vector measurement regions;
a step of selecting, from among the sub-pixel precision motion vectors, a sub-pixel precision motion vector corresponding to each motion vector of the most numerous motion vectors; and
a step of determining a representative vector on the basis of the selected sub-pixel precision motion vectors, and determining the positional displacement amount between the plurality of images by converting the determined representative vector at a conversion ratio employed to convert the reduced positioning images into the plurality of images prior to the reduction.
